(19) United States
(12) Patent Application Publication
(10) Pub. No.: US 2018/0198901 A1
(43) Pub. Date: Jul. 12, 2018

(54) ELECTRONIC DEVICE

(71) Applicant: KYOCERA Corporation, Kyoto-shi (JP)

(72) Inventors: Saki KUBO, Kawasaki-shi (JP); Shuto KONISHI, Yokohama-shi (JP)

(21) Appl. No.: 15/861,715

(22) Filed: Jan. 4, 2018

(30) Foreign Application Priority Data
Jan. 6, 2017 (JP) 2017-001381

(51) Int. Cl. H04M 1/21; G01K 1/14; H04M 1/02; G01K 13/00

(52) U.S. Cl. CPC H04M 1/21; G01K 1/14; H04M 2250/12; G01K 13/00; H04M 1/026

(57) ABSTRACT

The electronic device includes a case, a temperature sensor and a substrate on which the temperature sensor is disposed. The temperature sensor is accommodated in formed by the case and the substrate, and the space vents to outside of the case.

### CROSS-REFERENCE TO RELATED APPLICATION

This application claims priority to and the benefit of Japanese Patent Application No. 2017-001381 filed Jan. 6, 2017, the entire contents of which are incorporated herein by reference.

### TECHNICAL FIELD

This disclosure relates to an electronic device and, more particularly, to an electronic device such as a mobile communication terminal with a temperature sensor.

### BACKGROUND

In relation to recent mobile communication terminals such as mobile phones or smartphones, attempts have been made to enable detection of various data by installing various sensors in addition to the original call/communication functions. For example, a technology has been proposed in which an outside air temperature detector is installed in a mobile terminal to enable acquisition of information indicating the outside air temperature around the current position of the mobile terminal.

### SUMMARY

An electronic device according to an embodiment of this disclosure includes a case, a temperature sensor and a substrate on which the temperature sensor is disposed. The temperature sensor is accommodated in a space which is formed by the case and the substrate, and the space vents to outside of the case.

Further, an electronic device according to an embodiment of this disclosure includes a case configured to form a first space and a second space and a temperature sensor disposed in the first space. The first space is configured to be smaller than the second space and to vent to outside of the case, and the second space stores another substrate that is different from a substrate on which the temperature sensor is disposed.

### BRIEF DESCRIPTION OF THE DRAWINGS

In the accompanying drawings:

FIG. 1A is an external perspective view of an electronic device in a closed state according to an embodiment of this disclosure;

FIG. 1B is an external perspective view of an electronic device in a closed state according to an embodiment of this disclosure;

FIG. 2A is an external perspective view of the electronic device in an opened state according to the embodiment of this disclosure;

FIG. 2B is an external perspective view of the electronic device in an opened state according to the embodiment of this disclosure;

FIG. 3 is an exploded perspective view of an upper housing of the electronic device according to the embodiment of this disclosure;

FIG. 4 is an exploded perspective view of a case of the electronic device according to the embodiment of this disclosure;

FIG. 5 is an enlarged perspective view of the case of the electronic device according to the embodiment of this disclosure;

FIG. 6 is an enlarged front view of the case of the electronic device according to the embodiment of this disclosure;

FIG. 7 is a cross-sectional view of the case of the electronic device according to the embodiment of this disclosure;

FIG. 8 is an enlarged view of the case of the electronic device according to the embodiment of this disclosure; and

FIG. 9 is an enlarged view illustrating the case of the electronic device according to another embodiment of this disclosure.

### DETAILED DESCRIPTION

It is advantageous if a temperature such as ambient temperature can be measured quickly and accurately by an electronic device such as mobile phones or smartphones equipped with a temperature sensor. Hereinafter, embodiments of this disclosure are described in detail below with reference to the drawings.

The embodiments of this disclosure described below are explained in terms of a feature phone type mobile phone as an example of an electronic device. Further, the explanation is provided in terms of what is referred to as a fold-type (flip or clamshell type) feature phone as an example of a feature phone type mobile phone. However, the embodiments of this disclosure are not limited to a fold-type mobile phone, and may be a feature phone such as a bar (straight) type or a slide type in which a keyboard appears when sliding. Further, the embodiments of this disclosure are not limited to a feature phone type mobile phone, and may be a smartphone, for example.

Further, embodiments of this disclosure are not necessarily limited to mobile phones, and may be various electronic devices such as a tablet terminal, a remote control terminal that remotely controls an electronic device, a digital camera and a laptop PC. Accordingly, the embodiments of this disclosure may be any electronic device which is equipped with a temperature sensor.

The feature phone type mobile phone according to this embodiment is configured with an operating system (OS) such as Android® (Android is a registered trademark in Japan, other countries, or both) installed thereon. The OS responds to operation of a touch panel (or a touch screen) formed integrally with a display. However, a feature phone type mobile phone according to this embodiment may also be a mobile phone that does not include a touch screen and is operated by physical keys, for example.

Further, the feature phone type mobile phone according to this embodiment includes a touch screen, and, operations which can be performed via the touch screen can also be performed via physical keys. The feature phone type mobile phone according to this embodiment is not limited to a case where all operations which can be performed via the touch screen can also be performed via the physical keys, and in other cases only some of the operations which can be performed via the touch screen can be performed via the physical keys. Furthermore, the electronic device according to this embodiment may be a smartphone wherein all functions can be performed via a touch screen.

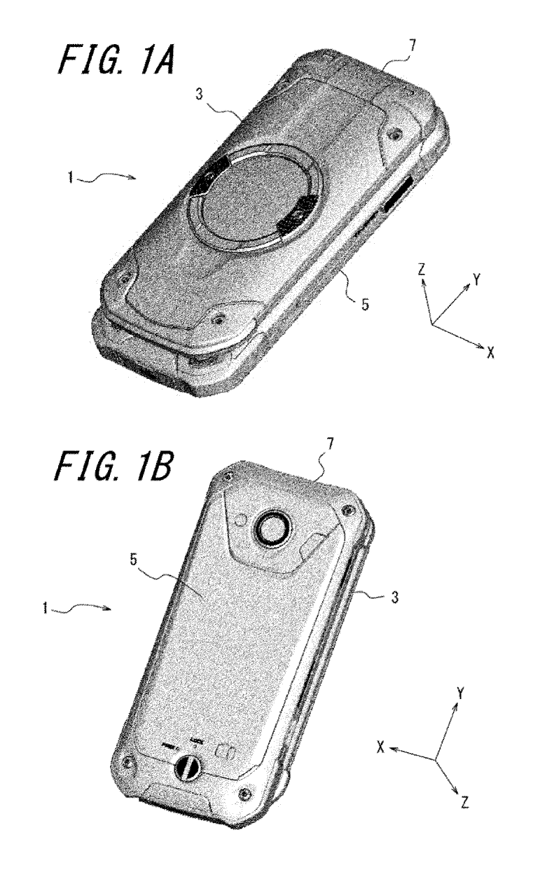

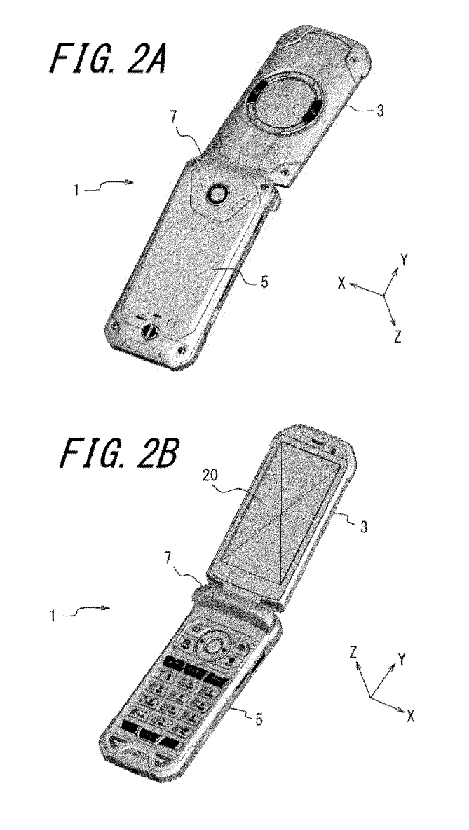

FIGS. 1A, 1B, 2A, and 2B are perspective views illustrating the appearance of the electronic device according to the embodiment of this disclosure. FIGS. 1A and 1B illustrate a state in which the electronic device according to the embodiment of this disclosure is closed. FIGS. 2A and 2B illustrate a state in which the electronic device according to the embodiment of this disclosure is opened.

As illustrated in FIGS. 1A and 1B, in relation to appearance, the electronic device 1 according to this embodiment is configured to include an upper housing 3 and a lower housing 5. The upper housing 3 and the lower housing 5 are connected at a movable part 7. The movable part 7 may be configured as a hinge, for example. FIGS. 1A and 1B illustrate a state in which the upper housing 3 and the lower housing 5 of the electronic device 1 are closed with respect to each other.

FIGS. 1A and 1B illustrate surfaces on opposite sides of the electronic device 1. In other words, FIG. 1B illustrates a state in which the electronic device 1 as illustrated in FIG. 1A is rotated by 180 degrees around the Y-axis. FIG. 1A mainly illustrates the upper housing 3 of the electronic device 1. In other words, FIG. 1A mainly illustrates the front side of the electronic device 1 when it is closed. Further, FIG. 1B mainly illustrates the lower housing 5 of the electronic device 1. In other words, FIG. 1B mainly illustrates the back side of the electronic device 1 when it is closed.

FIGS. 2A and 2B illustrate a state in which the upper housing 3 and the lower housing 5 of the electronic device 1 are opened with respect to each other. As illustrated in FIGS. 1A, 1B, 2A, and 2B, in the electronic device 1, the upper housing 3 and the lower housing 5 can be opened and closed with respect to each other by the movable part 7.

FIGS. 2A and 2B illustrate surfaces on opposite sides of the electronic device 1. In other words, FIG. 2B illustrates a state in which the electronic device 1 as illustrated in FIG. 2A is rotated by 180 degrees around the Y-axis. FIG. 2A mainly illustrates the exterior of the upper housing 3 and the lower housing 5 of the electronic device 1. In other words, FIG. 2A mainly illustrates the exterior of the electronic device 1 when it is opened. Further, FIG. 2B mainly illustrates the interior of the upper housing 3 and the lower housing 5 of the electronic device 1. In other words, FIG. 2B mainly illustrates the interior of the electronic device 1 when it is opened.

As illustrated in FIG. 2B, the electronic device 1 includes a display 20 on the interior of the upper housing 3. The display 20 may be configured as a liquid crystal display (LCD) or an organic EL display or an inorganic EL display. The electronic device 1 can display various elements such as characters, icons and images on the display 20.

Further, as illustrated in FIG. 2B, the electronic device 1 includes various operation keys on interior of the lower housing 5. These various operation keys detect operations by the user. The electronic device 1 can perform various processes or operations in response to user operations detected via the various operation keys.

The electronic device 1 according to this embodiment includes a temperature sensor configured to detect temperature. The electronic device 1 according to this embodiment has a temperature sensor which is internal to the upper housing 3 as described later. The electronic device 1 according to this embodiment can display information about temperature on the display 20 or output the information as a voice on basis of the temperature information detected by the temperature sensor. The electronic device 1 according to this embodiment is characterized in particular by a configuration in which the temperature sensor is disposed in the electronic device. Thus, the below description relates mainly to the upper housing 3 with the internal temperature sensor, and illustration and description of other functional parts will be simplified or omitted as appropriate. Further, a part or all of the upper housing 3 will be referred to as merely “case” as appropriate.

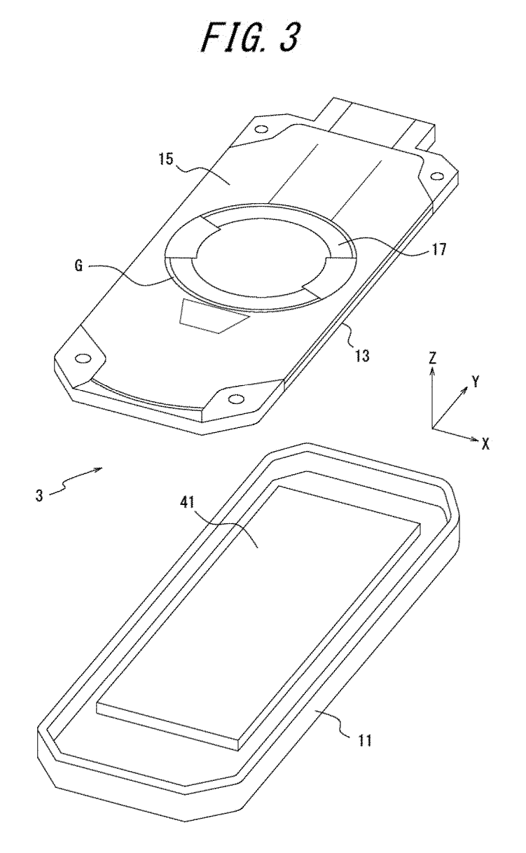

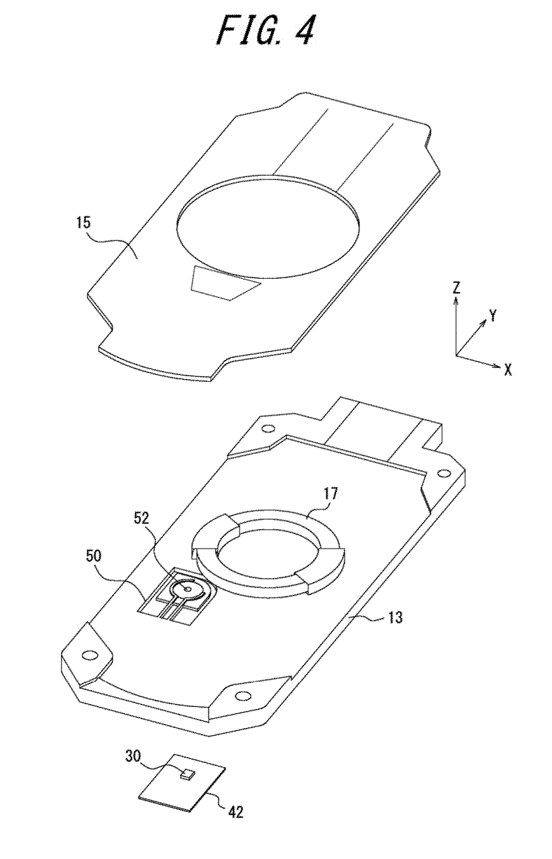

FIGS. 3 and 4 are perspective views illustrating the upper housing 3 of the electronic device 1 in a disassembled state.

FIG. 3 illustrates a state in which the upper case 13 is detached from the lower case 11 of the upper housing 3. As illustrated in FIG. 3, a display substrate 41 is disposed on the lower case 11. The display 20 illustrated in FIG. 2B is disposed on the display substrate 41. Further, in addition to the display 20, various other functional parts may be disposed on the display substrate 41. The interior of the lower case 11 and the upper case 13 may have various built-in functional parts. Thus, preferably, the lower case 11 and the upper case 13 may respectively be composed of materials such as rigid plastics or metals that have appropriate robustness.

As illustrated in FIG. 3, at least a part of the surface (facing the positive direction of the Z-axis) of the upper case 13 is covered with an exterior panel 15. The exterior panel 15 can apply a decorative design to the appearance of the electronic device 1 as well as protect the electronic device 1. Further, the exterior panel 15 covers various components disposed on the surface (facing the positive direction of the Z-axis) of the upper case 13 to prevent the components from being exposed on the surface of the electronic device 1. The exterior panel 15 functions as a decorative design and to protect the electronic device 1, and thus, preferably, is composed of materials such as rigid plastics that have appropriate robustness.

The exterior panel 15 has an opening near its center, for example. In the example illustrated in FIG. 3, a circular external decoration 17 is provided on the upper case 13 and is exposed through the circular opening near the center of the exterior panel 15.

FIG. 4 illustrates a state in which the exterior panel 15 is detached from the upper case 13. As illustrated in FIG. 4, the case 13 has the external decoration 17. The external decoration 17 may be formed separately and mounted on the case 13, or the external decoration 17 may be integrated with the case 13. The external decoration 17 may also be used to apply a decorative design to the appearance of the electronic device 1. The external decoration 17 may be composed of any materials including rigid plastics or metals, for example. Further, in addition to its decorative function, the external decoration 17 may be provided with a display such as a sub-display in the center thereof or an operation part such as a push button switch.

As illustrated in FIGS. 3 and 4, the external decoration 17 is exposed to the outside of the electronic device 1 through the opening of the exterior panel 15. In the examples illustrated in FIGS. 3 and 4, the external decoration 17 is circular in shape. However, it may have various shapes depending on design preference. In this case, the opening of the exterior panel 15 formed to expose the external decoration 17 is formed with consideration to the peripheral shape of the external decoration 17 and may further enhance the design.

In this manner, in this embodiment, a part of the upper case 13 can be covered with or exposed by the exterior panel 15 and the external decoration 17. Thus, in the electronic device 1, decoration may be applied such that the electronic device 1 has an appearance having high design quality.

In the electronic device 1 according to this embodiment, as illustrated in FIG. 3, the upper case 13 has a gap G between the exterior panel 15 and the external decoration 17. The gap G is formed between the opening of the exterior panel 15 and the external decoration 17. This gap G can, for example, allow free passage of gas such as the air.

In this manner, the electronic device 1 according to this embodiment includes the exterior panel 15 configured to cover at least a part of the upper case 13. The upper case 13 has the external decoration 17. Further, in the electronic device 1, the space in which the temperature sensor 30 is accommodated vents through the gap G between the external decoration 17 and the exterior panel 15.

As illustrated in FIG. 4, in a state in which the exterior panel 15 is detached from the upper case 13, a substrate disposition part 50 is exposed such that it can be seen from outside. The substrate disposition part 50 of the upper case 13 is a region having a back side (facing the negative direction of the Z-axis) on which a temperature sensor substrate 42 is disposed. As illustrated in FIG. 4, the temperature sensor 30 is disposed on the temperature sensor substrate 42.

The temperature sensor 30 may, for example, be configured to include a thermistor, but any member that can detect temperature may be adopted. In this embodiment, preferably, the temperature sensor 30 is small enough to be disposed on the temperature sensor substrate 42 that is disposed on the back side of the substrate disposition part 50. Further, preferably, the temperature sensor substrate 42 on which the temperature sensor 30 is disposed is composed of materials which are rigid enough to avoid damage by a light impact. Hereinafter the temperature sensor substrate 42 will be described as a substrate on which the temperature sensor 30 is disposed. However, various members other than the temperature sensor 30 may be disposed on the temperature sensor substrate 42. As described later, the temperature sensor substrate 42 is affixed to the back side of the substrate disposition part 50 with appropriate adhesives (or adhesive members) such as double sided tape.

As illustrated in FIG. 4, the substrate disposition part 50 has a vent 52 to allow ventilation of outside air to the temperature sensor 30. The temperature sensor 30 can detect the temperature of the outside air flowing in and out through the vent 52.

Next, the structure in the vicinity of the temperature sensor 30 is further described.

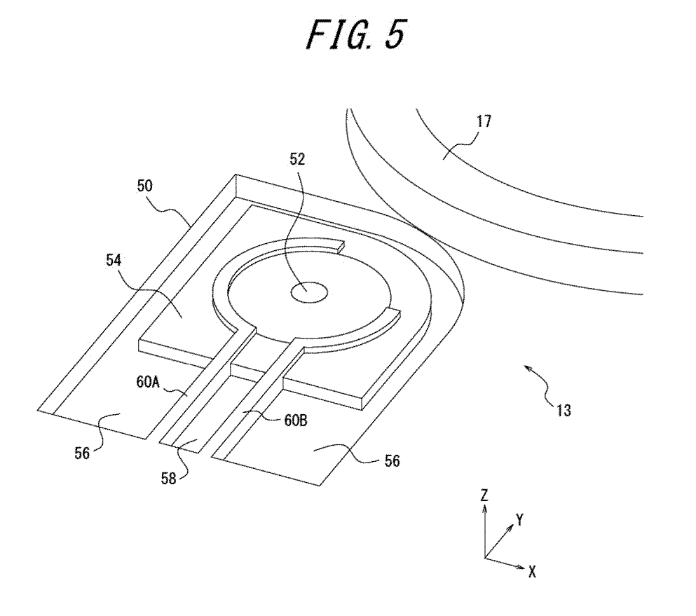

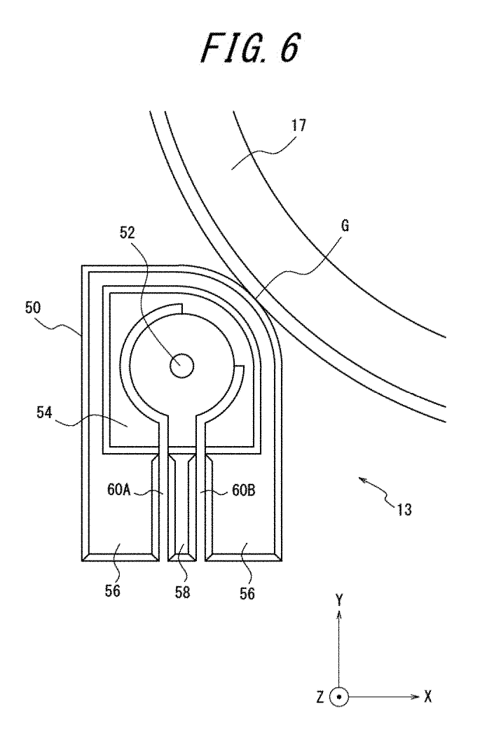

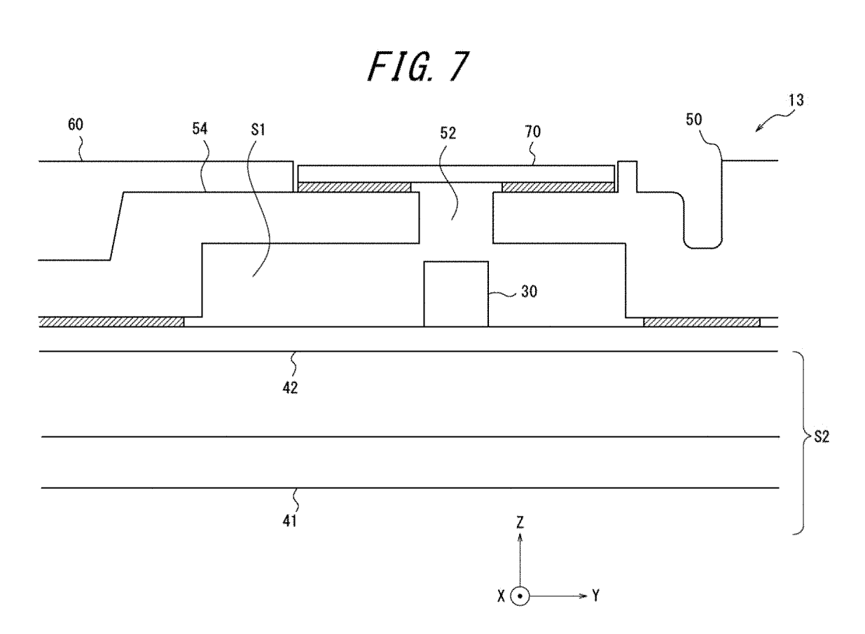

FIGS. 5 and 6 are enlarged views that mainly illustrate the substrate disposition part 50 formed on the upper case 13. FIG. 5 is an enlarged perspective view which mainly illustrates the substrate disposition part 50. FIG. 6 is a diagram in which the substrate disposition part 50 is mainly enlarged and viewed from above (facing the negative direction of the Z-axis). Further, FIG. 7 illustrates a cross-section of a plane parallel to the direction of YZ with respect to the substrate disposition part 50 illustrated in FIGS. 5 and 6.

As illustrated in FIGS. 5 and 6, the substrate disposition part 50 is provided at the periphery of the external decoration 17 on the case 13. This allows the outside air to flow into or out from the substrate disposition part 50 through the gap G when the exterior panel 15 is affixed to the case 13 (see FIGS. 3 and 4).

Further, as illustrated in FIGS. 5 and 6, the substrate disposition part 50 has partially concaved recesses 56 and 58 to allow smooth inflow and outflow of the outside air. Further, the recesses 56 and 58 are provided slightly lower (in the negative direction of the Z-axis) than the surface (facing the positive direction of the Z-axis) of the upper case 13. Thus, the back side (facing the negative direction of the Z-axis) of the recesses 56 and 58 can be formed flat. Therefore, even if the upper case 13 is formed such that it entirely curves, the back side (facing the negative direction of the Z-axis) of the recesses 56 and 58 is formed flat, and the temperature sensor substrate 42 in a flat state can be securely affixed to the back side.

As illustrated in FIG. 7, on the back side (facing the negative direction of the Z-axis) of the upper case 13, the temperature sensor substrate 42 is affixed to the position which almost corresponds to the substrate disposition part 50. Preferably, the temperature sensor substrate 42 is securely attached by using double sided tape or adhesive as appropriate. In FIG. 7, double sided tape or adhesive used for attaching the temperature sensor substrate 42 is illustrated as hatched area. Furthermore, preferably, in the temperature sensor substrate 42, the periphery of the temperature sensor 30 is enclosed by double sided tape or adhesive to allow the space between the temperature sensor substrate 42 and the back side (facing the negative direction of the Z-axis) of the case 13 to be sealed. As a result of this, inflow and outflow of fluid does not occur between the space S1 in which the temperature sensor is disposed and the space S2 on the back side (facing the negative direction of the Z-axis) of the upper case 13.

Further, as illustrated in FIGS. 5 and 6, although the substrate disposition part 50 has partially concaved recesses 56 and 58, it also has a partially projected accommodation portion 54. As illustrated in FIG. 7, this projected accommodation portion forms the space S1 in which the temperature sensor 30 is disposed. This space S1 is ventilated to the outside air, and thus the temperature sensor 30 can satisfactorily detect the ambient temperature. Preferably, the height (in the positive direction of the Z-axis) of the accommodation portion 54 is almost the same as or slightly less (in the negative direction of the Z-axis) than that of the surface (facing the positive direction of the Z-axis) of the upper case 13. In this manner, when the exterior panel 15 is affixed to the upper case 13, the exterior panel 15 can be prevented from interfering with the accommodation portion 54.

Further, as illustrated in FIGS. 5 and 6, the substrate disposition part 50 has rib-like projections 60A and 60B formed to have almost the same height as that of the surface (facing the positive direction of the Z-axis) of the upper case 13. Although these projections 60A and 60B form a pair in FIGS. 5 and 6, in some cases it may be sufficient for at least either one of them to be provided. The exterior panel 15 can be supported when it is affixed to the upper case 13 by forming the projections 60A and 60B such that they have almost the same height as that of the surface (facing the positive direction of the Z-axis) of the upper case 13. These projections 60A and 60B allow a part of the substrate disposition part 50 to have almost the same height as that of the surface (facing the positive direction of the Z-axis) of the upper case 13. Thus, the projections 60A and 60B serve to reinforce the exterior panel. Therefore, satisfactory results may be obtained in a static pressure test of the electronic device 1 with respect to the exterior panel 15, for example.

Further, as illustrated in FIGS. 5 and 6, a passage (e.g. the recess 58) that allows inflow and outflow of gas such as air can be formed between the projections 60A and 60B by providing at least two projections 60A and 60B such that a pair can be formed. In this manner, the inflow and outflow of air through the recess 58 is satisfactory, and thus the temperature sensor 30 can detect the ambient temperature satisfactorily and quickly.

In this manner, the electronic device 1 according to this embodiment includes the exterior panel 15 configured to cover at least a part of the upper case 13. The upper case 13 has the projection 60 configured to support the exterior panel 15. Further, in the electronic device 1, the projection 60 reinforces the exterior panel 15. Furthermore, in the electronic device 1, the upper case 13 may have at least two projections 60 (60A, 60B). Then, in the electronic device 1, the recess 58 formed by at least two projections (60A, 60B) may serve as a passage that allows the space that accommodates the temperature sensor 30 to vent to outside of the case 13.

As illustrated in FIGS. 5 and 6, in the substrate disposition part 50, the accommodation portion 54 includes the vent 52, which is a hole to allow ventilation of the outside air to the temperature sensor 30. As described above, the outside air freely flows into and out from the substrate disposition part 50, and thus not only gas but also water may enter through the vent 52. Therefore, in the electronic device 1 according to this embodiment a waterproof breathable membrane 70 is affixed to the accommodation portion 54, as illustrated in FIG. 7, to cover the vent 52. The waterproof breathable membrane 70 is composed of a material that is permeable to gas, but not to liquid. For example, the waterproof breathable membrane 70 may be composed of a seal tape made of a waterproof and breathable material such as GORE-TEX® (GORE TEX is a registered trademark in Japan, other countries, or both). As illustrated in FIG. 7, when the waterproof breathable membrane 70 is affixed to the accommodation portion 54, preferably, double-sided tape or adhesive may be used as appropriate for secure attachment. In FIG. 7, double sided tape or adhesive used for attaching the waterproof breathable film 70 is illustrated as hatched area. Further, instead of the waterproof breathable membrane 70, a membrane having either breathability or water resistance may be affixed to the vent 52 depending on the environment where the electronic device 1 is to be used.

In this manner, in the electronic device 1 according to this embodiment, the vent 52 configured to vent to outside of the upper case 13 may be covered with a member having at least either breathability or water resistance (e.g. the waterproof breathable membrane 70). As illustrated in FIG. 7, water is prevented from entering the space S1 in which the temperature sensor 30 is disposed from outside the upper case 13 by blocking the vent 52 with a waterproof member. Therefore, malfunction of the temperature sensor 30 due to exposure to water can be prevented.

As described above, the electronic device 1 according to this embodiment includes the upper case 13, the temperature sensor 30 and the substrate (temperature sensor substrate 42) on which the temperature sensor 30 is disposed. Further, in the electronic device 1, the space S1 in which the temperature sensor 30 is stored is formed by the upper case 13 and the temperature sensor substrate 42, and the space S1 vents to outside of the upper case 13.

Further, in the electronic device 1, the upper case 13 has a hole (vent 52) configured to vent to outside of the upper case 13. Further, in the electronic device 1, the temperature sensor substrate 42 is disposed closer to the vent 52 than another substrate (display substrate 41) disposed on the upper case 13.

Further, the upper case 13 (and the lower case 11) form the space S2 in which the display substrate 41 is disposed. Further, the space S1 in which the temperature sensor 30 is accommodated is formed separately from the space S2 in which the display substrate 41 is disposed.

As illustrated in FIG. 7, the space S1 in which the temperature sensor is accommodated is formed on the back side (facing the negative direction of the Z-axis) of the upper case 13. Further, separately from the space S1, the space S2 in which the display substrate 41 or the like is accommodated is also formed on the back side (facing the negative direction of the Z-axis) of the upper case 13 by the upper case 13 and the lower case 11. Since the space S1 and the space S2 are separate spaces in the electronic device 1, even if the display 20 disposed on the display substrate 41 generates heat, for example, the influence of the generated heat on detection by the temperature sensor 30 accommodated in the space S1 is suppressed.

Further, as illustrated in FIG. 7, the temperature sensor substrate 42 on which the temperature sensor 30 is disposed is located closer to the vent 52 than the display substrate 41. Therefore, in the electronic device 1, the temperature of the gas flowing in/out through the vent 52 can be detected more accurately than the case where the temperature sensor 30 is disposed on another substrate such as the display substrate 41, for example. The response time for the temperature sensor 30 to detect the ambient temperature can be increased by increasing the rate of inflow and outflow of the gas through the vent 52. Further, ventilation of the air in the space S1 in which the temperature sensor 30 is accommodated can be accelerated by increasing the rate of inflow and outflow of the gas through the vent 52.

Further, the electronic device 1 according to the embodiment of this disclosure includes cases (11, 13) configured to form the first space S1 and the second space S2, and the temperature sensor 30 disposed in the first space S1. In the electronic device 1, the first space S1 is configured to be smaller than the second space S2 and to vent to outside of the cases (11, 13). Further, in the electronic device 1, the second space S2 accommodates another substrate (display substrate 41) which is different from the substrate (temperature sensor substrate 42) on which the temperature sensor 30 is disposed.

As illustrated in FIG. 7, in the electronic device 1 according to this embodiment, the space S1 in which the temperature sensor 30 is accommodated may be a distinct space dedicated to detection of temperature. By configuring the space S1 as smaller than the space S2, for example, the temperature sensor 30 can detect temperature with minimal interference from other parts of the electronic device 1.

Next, a configuration in which a passage that allows air to vent between the upper case 13 and the exterior panel 15 is formed in the electronic device 1 will be described.

As illustrated in FIG. 4, in a process for manufacturing the electronic device 1, the exterior panel 15 is affixed to the upper case 13. When the exterior panel 15 is affixed to the upper case 13, preferably, double-sided tape or adhesive may be used. When the exterior panel 15 is affixed to the upper case 13, preferably, the areas to be affixed to each other by double-sided tape or adhesive should be as large as possible, to achieve the necessary strength.

However, when double sided tape is affixed or adhesive is applied to the entire area of the back side (facing the negative direction of the Z-axis) of the exterior panel 15, flowing in/out of the gas through the gap G is disturbed. In this case, the temperature sensor 30 cannot detect temperature quickly and accurately. Therefore, in the electronic device 1 according to this embodiment, even if the exterior panel 15 is affixed to the upper case 13, a passage to allow the gas to vent is secured between the upper case 13 and the exterior panel 15.

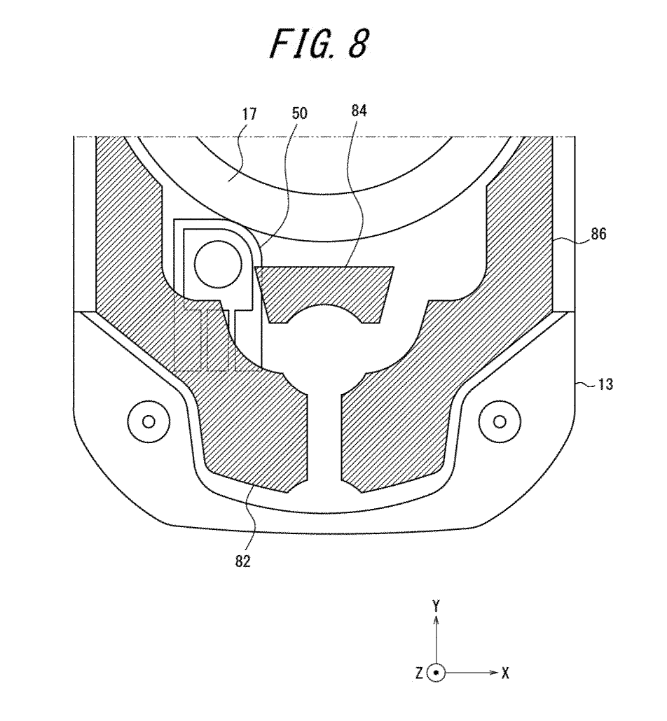

FIG. 8 illustrates a partially enlarged view of the upper case 13. FIG. 8 illustrates a state before the exterior panel 15 is affixed to the upper case 13 illustrated in FIG. 4.

As illustrated in FIG. 8, when the exterior panel 15 is affixed to the upper case 13 of the electronic device 1, double sided tape is affixed not to the entire adhesive surface, for example, and is affixed with a part thereof cut out. In FIG. 8, the double sided tape is divided into three parts, 82, 84 and 86 to attach the exterior panel 15 to the upper case 13. In the example illustrated in FIG. 8, a passage that allows the gas entering from the gap G to flow from the upper left direction to downward through the center (or the reverse direction) is secured by the three partial double sided tapes 82, 84 and 86. This passage allows the electronic device 1 to vent the gas between the upper case 13 and the exterior panel 15 even after the exterior panel 15 is affixed to the upper case 13.

In the example illustrated in FIG. 8, three partial double sided tapes 82, 84 and 86 are used. However, instead of the double sided tape, adhesive may be applied to three parts in a partial manner. Further, in the example illustrated in FIG. 8, completely separated members such as double sided tapes 82, 84 and 86 are used. However, these are not necessarily completely separated. For example, even if double sided tape is affixed or adhesive is applied to the entire back side (facing the negative direction of the Z-axis) of the exterior panel 15, the thickness of the adhesive layer may be partially reduced to form a passage of the gas in the same manner.

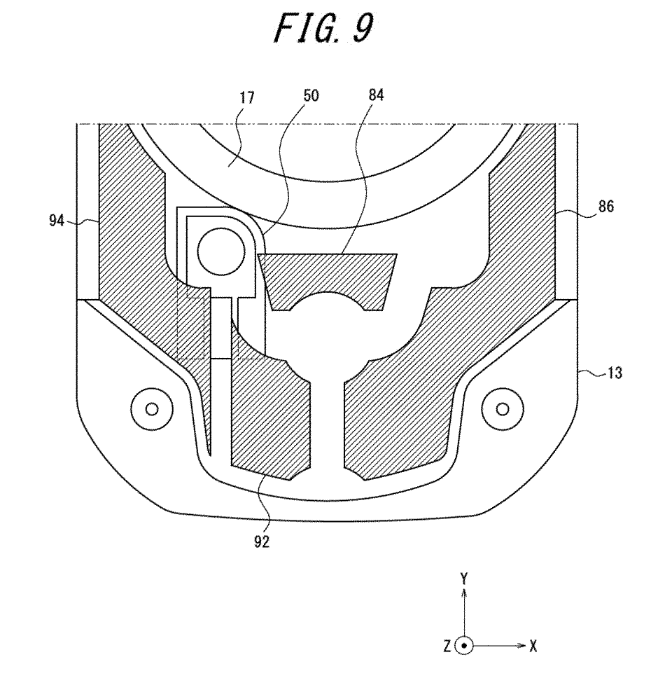

FIG. 9 illustrates a variation of the structure illustrated in FIG. 8. In the example illustrated in FIG. 9, the double sided tape 82 is further divided into two areas, and double sided tapes 92 and 94 are used. In FIG. 9, the two double sided tapes 92 and 94 are attached along the recess 58 formed between the projections 60A and 60B (see FIG. 6). In this manner, when a passage (e.g. the recess 58) that allows the gas such as the air to flow in/out is formed between the projections 60A and 60B, ventilation of the gas flowing through the passage can be further promoted.

As described above, the electronic device 1 according to this embodiment includes the exterior panel 15 configured to cover at least a part of the upper case 13. Further, in the electronic device 1, a passage that allows the space S1 in which the temperature sensor 30 is accommodated to vent to outside of the case 13 is provided by partially reducing the thickness of the adhesive layer (e.g. the double sided tapes 82 to 92) that adhere between the exterior panel 15 and the upper case 13. In this manner, a temperature such as air temperature can be measured quickly and accurately.

As described above, according to this embodiment, it is possible to satisfactorily measure a temperature such as air temperature.

Although this disclosure is described on the basis of the accompanying drawings and examples, it is to be noted that various changes and modifications will be apparent to those skilled in the art based on this disclosure. Therefore, such changes and modifications are to be understood as being included within the scope of this disclosure. For example, the functions and the like included in the various functional parts, means, and steps may be reordered in any logically consistent way. Furthermore, functional parts or steps may be combined into one or divided. The above embodiment of this disclosure is not limited to being implemented precisely as described and may be implemented by combining or partially omitting the features thereof.

### Reference Signs List

1 Electronic device
3 Upper housing
5 Lower housing
7 Movable part
11 Lower case
13 Upper case (case)
15 Exterior panel
17 External decoration
20 Display
30 Temperature sensor
41 Display substrate (another substrate)
42 Temperature sensor substrate (substrate)
50 Substrate disposition part
52 Vent
54 Accommodation portion (temperature sensor accommodation portion)
56, 58 Recess
60A, 60B Projection (rib)
70 Waterproof breathable film
82, 84, 86, 92, 94 Double sided tape

1. An electronic device, comprising:
a case;
a temperature sensor; and
a substrate on which the temperature sensor is disposed, wherein
the temperature sensor is accommodated in a space which is formed by the case and the substrate, the space venting to outside of the case.

2. The electronic device according to claim 1, wherein
the case has a hole configured to vent outside the case; and
the substrate is disposed at a position closer to the hole than another substrate disposed in the case.

3. The electronic device according to claim 2, wherein
the case forms a space in which the another substrate is disposed; and
the space in which the temperature sensor is stored is formed separately from the space in which the another substrate is disposed.

4. The electronic device according to claim 2, wherein the hole configured to vent to outside of the case is covered with a member having at least one of breathability and water resistance.

5. The electronic device according to any one of claims 1, comprising an exterior panel configured to cover at least a part of the case, wherein the case has at least one projection configured to support the exterior panel.

6. The electronic device according to claim 5, wherein the at least one projection is configured to reinforce the exterior panel.

7. The electronic device according to claim 5, wherein
the at least one projection comprises at least two projections; and
a recess formed by the at least two projections serves as a passage configured to vent the space in which the temperature sensor is stored to outside of the case.

8. The electronic device according to any one of claims 1 comprising an exterior panel configured to cover at least a part of the case, wherein the case has an externally decorated portion, and the space in which the temperature sensor is stored vents through a gap between the externally decorated portion and the exterior panel.

9. The electronic device according to any one of claims 1 comprising an exterior panel configured to cover at least a part of the case, wherein a thickness of an adhesive layer that bonds the exterior panel and the case is partially reduced to form a passage that allows the space in which the temperature sensor is stored to vent to outside of the case.

10. An electronic device, comprising:
a case configured to form a first space and a second space; and
a temperature sensor disposed in the first space, wherein
the first space is configured to be smaller than the second space and to vent to outside of the case; and
the second space stores another substrate that is different from a substrate on which the temperature sensor is disposed.
